(19) United States
(12) Patent Application Publication
(10) Pub. No.: US 2008/0050700 A1
(43) Pub. Date: Feb. 28, 2008

(54) Methods And Devices For Producing Dentures

(75) Inventors: Gerhard Weber, Inning (DE); Stephan Holzner, Muhldorf am Inn (DE)

Correspondence Address: FLEIT KAIN GIBBONS GUTMAN BONGINI & BIANCO, 21355 EAST DIXIE HIGHWAY, SUITE 115, MIAMI, FL, 33180, US

(73) Assignee: WILLYTEC GMBH, Grafelfing (DE)

(21) Appl. No.: 11/570,283

(22) PCT Filed: Jun. 10, 2005
(86) PCT No.: PCT/DE05/01037

§ 371 Date: Oct. 22, 2007

(30) Foreign Application Priority Data
Jun. 10, 2004 (DE) 20 2004 009 128.3
Jun. 23, 2004 (DE) 20 2004 009 900.4

(51) Int. Cl. A61C 13/003

(52) U.S. Cl. 433/202.1; 29/896.1; 433/223

(57) ABSTRACT

The invention relates to methods and devices for producing denture elements, whereby surface data of a remaining dental area are digitally acquired, at least one molded part, especially a denture element for the remaining dental area, is three-dimensionally designed using the surface data of the remaining dental area acquired and corresponding mold data are produced, and the at least one denture element is partially or completely produced on the basis of the surface data and mold data, with one or more of the following aspects being taken into consideration: dimensionally designing web constructions between tooth stumps and producing corresponding mold data; acquiring surface data of a three-dimensional dental impression, on one side, on two sides or on several sides; graphically representing the surface data, fixing at least one mark on the graphical representation of the surface data, and constructing mold data for a denture element based on the surface data and taking into consideration the mark in the graphical representation of the surface data; producing primary crowns by means of 3+1 axes milling or angular axis milling techniques; optimally aligning a milled blank with the element to be milled by ‘uphill/downhill milling’; and or using for scanning the molding waxes a molding wax including at least ⅓ to ⅘ parts by weight of zirconium oxide powder.

### FIELD OF THE INVENTION

The invention concerns methods and devices for producing dentures, in particular, on the basis of CAD/CAM technology.

### BACKGROUND OF THE INVENTION

The goal of the invention under consideration, which it attains, is to improve existing technology. Furthermore, the invention under consideration creates, in an advantageous manner, cheaper and simple alternatives to the embodiments in the state of the art.

### SUMMARY OF THE INVENTION

To this end, methods and devices which can be implemented individually or combined in accordance with individual aspects of the invention are created as they are indicated in the individual independent claims. Advantageous and preferred refinements can be deduced from the individual dependent claims.

In particular, the invention creates methods and devices for the production of denture elements with a digital acquisition of surface data of a remaining dental area, three-dimensional designing of at least one molded part, in particular, of a denture element for the remaining dental area, including the acquired surface data of the remaining dental area and the preparation of corresponding mold data, and the partial or complete production of the at least one denture element on the basis of the surface data and mold data, wherein one or more of the following aspects are taken into consideration:

that within the framework of the three-dimensional design of at least one molded part, a three-dimensional design of web constructions between tooth stumps and the preparation of corresponding mold data take place, and that the mold data of the three-dimensional design of the web constructions between tooth stumps for the production of the denture element be passed on to a production device For a partial or complete production;

that surface data of a three-dimensional dental impression, which was produced by the introduction of a shapable material between the upper and lower jaws of a patient when his teeth are pressed together, be acquired on one side, on two sides (both sides), or on several sides, that both the surface data of the remaining dental area and also the surface data of the dental impression be depicted, wherein in a first step, the surface data of the remaining dental area of a plaster model be measured, that in another step, the plaster model be brought to a defined relative position with respect to the measuring device; that the dental impression be subsequently placed on the plaster model; and that the entire model together with the plaster impression be measured; that in another step, the spatial position of the data of the plaster model and the data of the dental impression relative to one another, be depicted and examined on a screen; and that in another step, the dental element be designed with the aid of the depictions of the plaster model and the dental impression;

that a total mold component be created from a combination and/or merging of configuration data of at least one predefined, three-dimensional body with mold data from at least one three-dimensionally designed denture element;

that in the digital acquisition of the surface data of a remaining dental area, data regarding the spatial position and shape of at least one implant post be acquired, that a stored abutment, suitable for the position of the tooth which the implant post replaces be selected from a database; that this abutment be placed in a representation of the remaining dental area with the implant post on the latter and be adapted to the remaining dental area;

that a desired abutment be molded with wax on an implant post; that this wax model be acquired in a separate scanning process; and that scanned or previously known configuration data of the implant post be brought together with the surface data set of the wax model so that a complete mold data set of an abutment be produced with upper and lower sides which are joined together;

that the surface data be depicted graphically; that at least one mark be made on the graphic representation of the surface data; and that mold data for a dental element based on the surface data, including the mark, be constructed in the graphic representation of the surface data;

that after a preliminary measurement on the plaster model, rough fittings be made; that the rough fittings be measured in a second scanning run; and that the two scans be correlated with one another in a very precise manner;

that during a molding or molding on a screen for the recognition of changes of the wall thicknesses, the local wall thicknesses of the restoration on the screen be marked in colored gradations are to be depicted partially transparent;

that a cavity be scanned; that subsequently, an edge detection be carried out: that afterwards, an inlay be molded in the model with wax and in this state scanning be carried out once more; that the two measurement data sets be superimposed with 3D matching; and that finally, a difference data set be calculated;

that a cavity be scanned; that afterwards, an inlay be molded in the model with wax and in this state scanning be carried out once more; that via a combined method of the “correlation,” in the form of a superimposition of two scans and the “distance detector” of the two scans, those areas/points be filtered out which are relevant for an inlay; and that finally a difference data set be calculated;

that a method for the volume subtraction be used;

that in a first step, by scanning a plaster model situation, the spatial position of implant posts or implant screws be determined; that in a second step, the configuration data of the implant posts, in particular, according to the manufacturers's specifications, be imported; that the imported data either be matched with the data determined in the 3D measurement or be shown on the screen; and that in a next step, crown or bridge constructions on the basis of the preceding step be constructed on the screen and be transmitted to the CNC machine for production;

that for the development of primary crowns, a friction line, present geometrically and visible on a screen, be selected on their data set; that a site or a point of the friction line be marked then; that proceeding from this point, an effect area be selected—that is, the width of a site to be changed; that in the next step, the friction line at this point be pulled over the selected effect area upwards, downwards, inwards, or outwards; and that a new topography of the primary crown result therefrom, with an automatic retention of the parallelness for the insertion direction or with the retention of the cone angle;

that primary crowns be made by means of 3+1 axis milling or angular axis milling techniques;

that an optimal aligning of a milled blank with the element to be milled take place by “uphill/downhill milling”; and/or

that for the scanning of the molding waxes, a molding wax be used with at least ⅓ to ⅘ parts by weight of zirconium oxide powder.

A device for the production of denture elements comprises installations for the digital acquisition of surface data of a remaining dental area, installations for the three-dimensional designing of at least one molded part, in particular, a denture element for the remaining dental area, including the acquired surface data of the remaining dental area and the preparation of the corresponding mold data; and installations are provided for the partial or complete production of the at least one denture element on the basis of the surface data and mold data, and installations are designed and coupled functionally with one another so as to carry out any of the previously explained methods, including, data processing installations, data storage installations, screen installations, input and output installations, and data transmission installations, and material processing installations to execute such methods in accordance with any of Claims 1-70.

### BRIEF DESCRIPTION OF THE DRAWINGS

The invention is explained in more detail with the aid of embodiment examples below, with reference to the drawings.

FIG. 1a shows the determination of the main insertion direction between two tooth stumps.

FIG. 1b shows the production of the crown outer surfaces which already run parallel or in the same angular position.

FIG. 1c shows insertion of the web between the tooth stumps.

FIGS. 1d and 1e show examples of a parallel or angular formation of the web.

FIG. 1f shows the secondary or tertiary construction shaped for the patient.

FIG. 2a shows depictions of the geometric dimensions of a rod attachment or a Schroeder pin.

FIGS. 2b and 2c show longitudinal scales inserted on the depiction of FIG. 2a.

FIG. 2d shows merger of the pin of FIG. 2a with the denture element.

FIGS. 3a and 3b show a bridge with two crowns linked to a pontic by connecting elements.

FIGS. 4a, 4b, 4c, 4d, 4e, and 4f show the steps involved in constructing a Maryland Bridge.

FIGS. 5a, 5b, 5c, 5d, and 5e shows the steps involved in the production of a primary crown.

FIG. 6 shows the positions and scalings of the pontic can be inserted in larger and smaller jaws from the programmed library using a method with a circle tangent model.

FIG. 7 shows the jutting edges produced in the set up of the main insertion direction.

FIG. 8 schematically shows a blank being milled.

### DETAILED DESCRIPTION OF THE INVENTION

With the aid of the embodiment and application examples described below and depicted in the drawings, the invention is explained in more detail only by way of example. Method and device features can also be deduced analogously from device or method descriptions.

The same reference symbols designate the same or similar components or components which act the same or similarly in the individual figures and depictions of the drawing. With the aid of the representations in the drawing, such features which are not provided with reference symbols also become clear, independent of whether such features are described below or not. On the other hand, features which are contained in the description under consideration but are not visible or depicted in the drawing are also readily understandable for a specialist.

Individual features which are indicated and/or represented in connection with concrete embodiment examples are not limited to these embodiment examples or the combination with the other features of these embodiment examples, but rather can be combined, within the framework of what is technically possible, with any other variants, even if they are not separately treated in the documents under consideration.

Based on the state of the art of previous patent applications of Willytec GmbH, amplifications of the technical application possibilities of the technologies were developed, as is explained more precisely below for individual aspects. The starting basis of the invention is that the three-dimensional data of a human jaw with prepared tooth stumps are available.

1. Web Constructions

This aspect of the invention is an improvement of so-called web constructions, which have been common in dental technology up to now, by means of CAD/CAM technology:

As connecting elements between the tooth stumps, webs, shaped right-angled or as trapezoids, are inserted into three-dimensional data of a human jaw with prepared tooth stumps by software. The crowning of the tooth stumps is carried out in several steps.

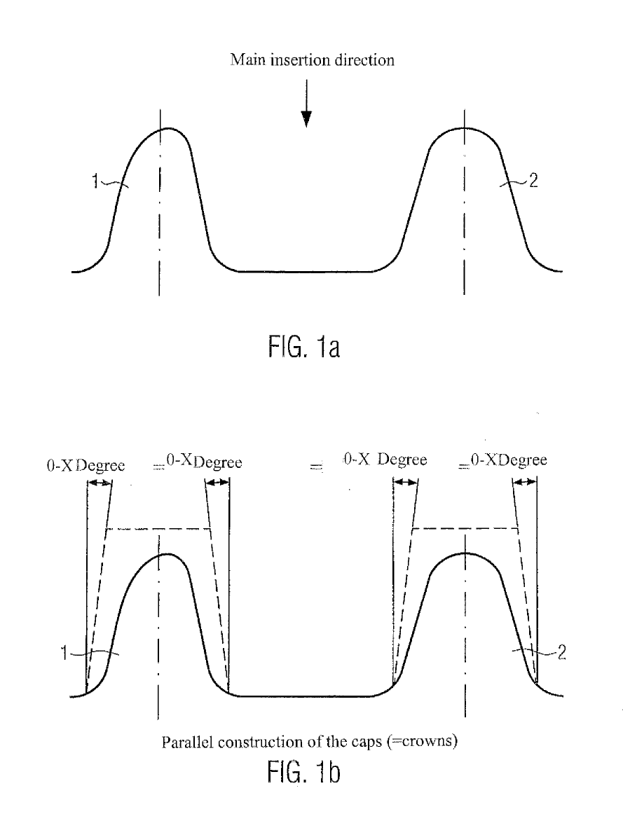

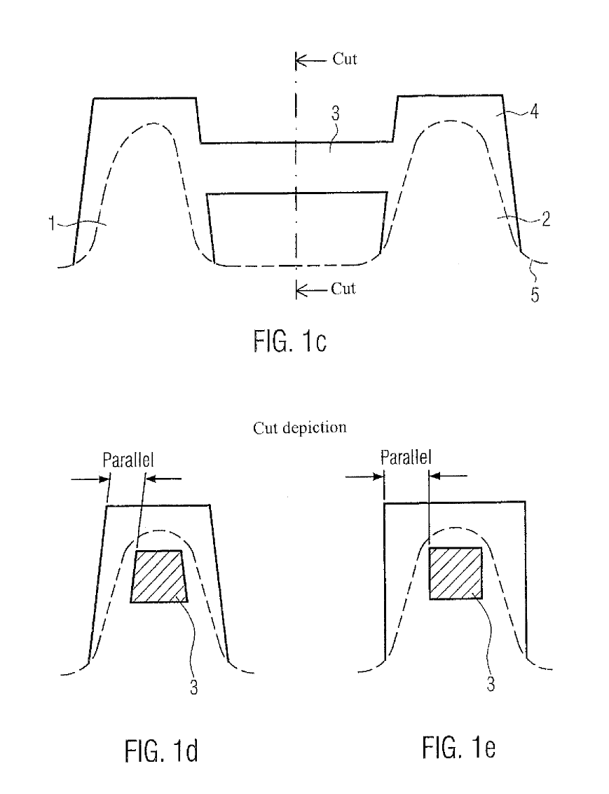

First, a main insertion direction (FIG. 1a) is determined by means of the software. Accordingly, crown outer surfaces which already run parallel or in the same angular position are produced by means of the software (FIG. 1b). The outer surfaces of all affected crowns are either aligned parallel relative to one another, or the defined crown angles are the same with reference to the main insertion direction (FIG. 1a). Therefore, after the main insertion direction was determined with the software, the web between the crown stumps can be inserted automatically so that its outer surfaces are also aligned parallel with respect to the main insertion direction (FIGS. 1c, 1d, 1e). FIGS. 1d and 1e show examples of a parallel or angular formation of the web. The surfaces can therefore also be formed in the usual conical angular positions (as a rule, 2°).

Thus, the entire situation is aligned parallel to the walls or conically and can accordingly be milled by the CNC machine in a very precise manner. The workpieces can be produced from the most varied materials, in particular, zirconium oxide ceramics, by means of CNC technology.

The outer data of this web construction under consideration can, in turn, be further processed as inner data for the secondary/tertiary construction (with the addition of a tolerance on fit) so that a perfect fit, which can be standardized for the first time by means of CNC milling technology, is produced. The secondary or tertiary construction is, as a rule, shaped for the patient so that it can be removed (FIG. 1f).

2. Insertion of the Counterbite into a Molding Software

This aspect of the invention is an improvement in the molding of dentures. To this end, the representation of the counterbite or the opposite jaw (by means of a computer) is advantageous.

A bite registering system (centric/functional)—designated as such by specialists—is set at the already measured model situation after the determination of the jaw data, for a second measurement run. In this second measurement run, this bite registering system will also measure, wherein the already measured model remains in the same position relative to the sensor, as in the first measurement run. Therefore, the spatial position of the bite registering system relative to the jaw model is known to the measurement system (computer). The spatial position is, for example, attained either as a result of the repositioning of the jaw and/or the repositioning through a software-technical process (matching) of the jaw model from the 1st scanning process and the 2nd scanning process.

The computer program handles the second measurement, however, in such a way that the bite registering system can be faded in or out for the purpose of the molding on the screen. Alternatively, the registering system can also be depicted in a transparent manner.

3. Rod Attachment/Schroeder Pin

The starting basis in this aspect of the invention is, furthermore, that data of a 3D data set of a denture element (for example, crown or bridge) to be provided with a rod attachment, are available. This aspect of the invention is an improvement in the dental technology of the usual, so-called rod attachments or Schroeder pins, as it has been known up to now.

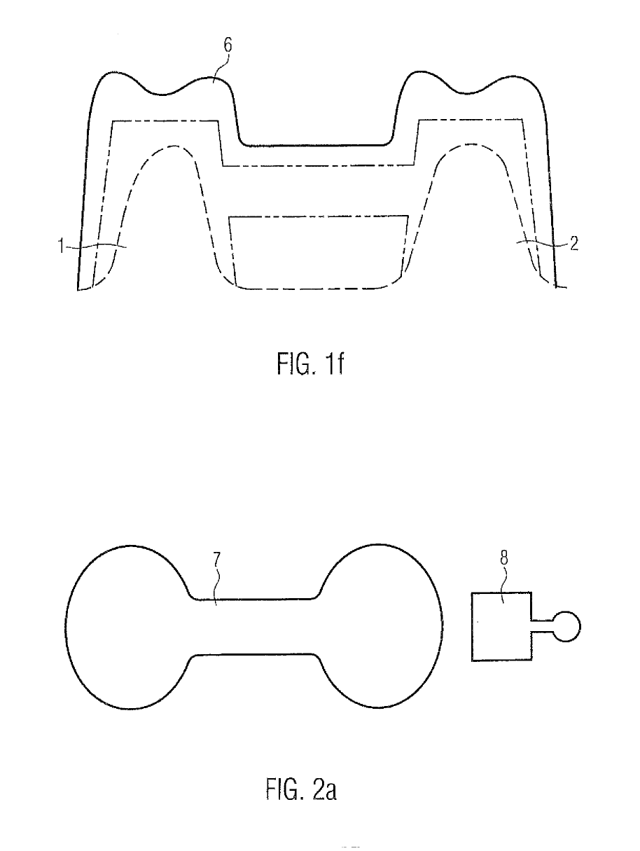

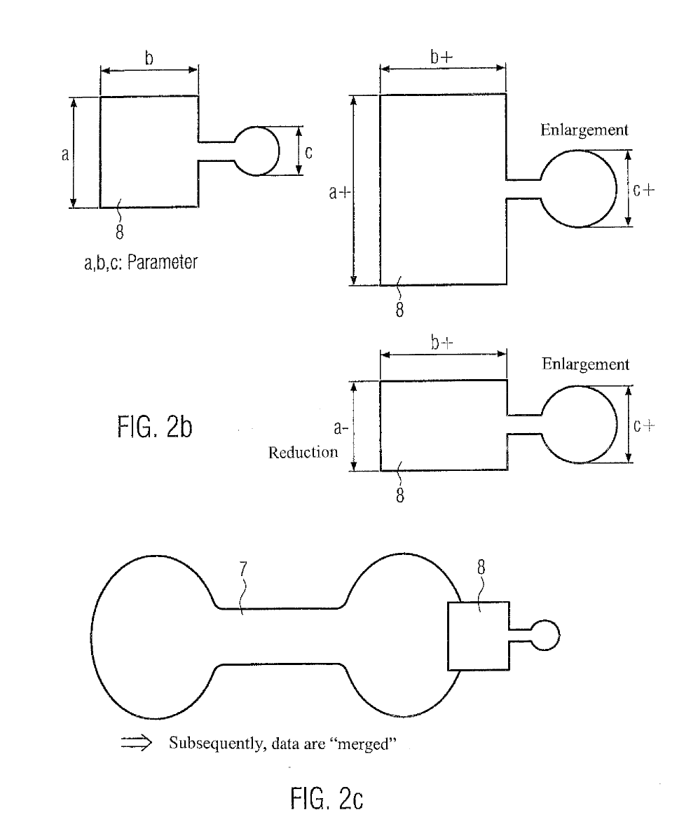

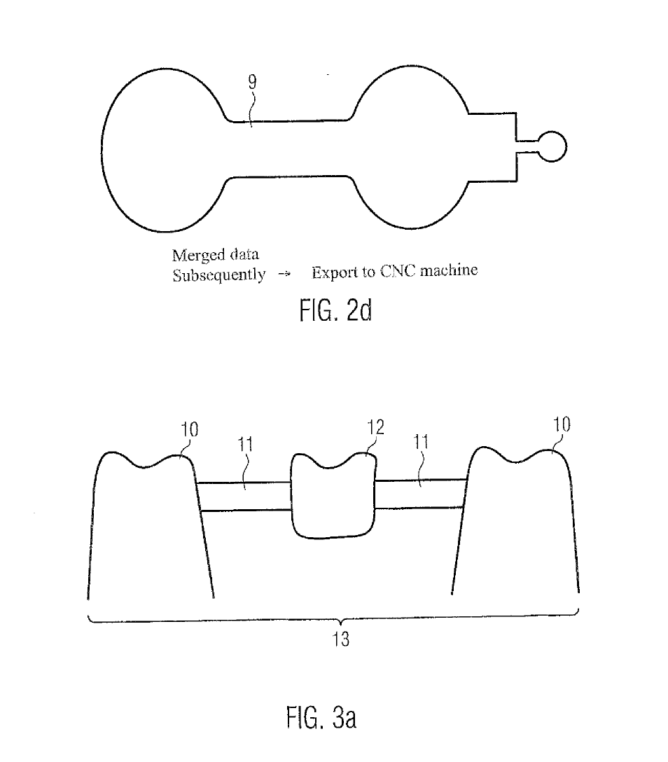

Geometrically predefined bodies (see above) can be added (imported) with or by software to the available data. Subsequently, the data can be “merged” with software technology so that a data set or a combination of data sets is produced, which can be further processed for production using a CNC machine. Accordingly, the geometric dimensions of a rod attachment or a Schroeder pin are imported to the existing denture data set in this dental-technical application case and depicted on a screen (FIG. 2a). Subsequently, the pin is spatially placed relative to the denture element, for example, by means of a mouse function, and merged (FIG. 2d) with the denture element, for example, bridge structure, with software technology or their spatial position, relative to one another can be stored. The configuration data can be imported in parametric form—that is: for example, stretched or compressed with the mouse—whereas longitudinal scales are inserted on the screen (FIGS. 2b, 2c).

In particular, a rod attachment (female mold) is suitable for connecting two (partial) bridges which require two different main insertion directions as a result of the dental-technical configurations and arrangements. This is better known as “division attachments,” wherein the Z direction of the rod attachment is taken from the main insertion direction of the second bridge. This ensures that, by means of a simple possibility, the rod attachment can be used as a connecting element for the two bridges.

With another refinement, the rod attachment is constricted in the function “division attachment” so that the already effected construction/configuration is suitable for determining the counterpiece (male mold) in that the rod attachment element is removed from the second bridge in a mathematical operation, as, for example, in accordance with boolean algebra, and in this way the suitable counterpiece is produced.

4. Expansion of the Pontic Database

This aspect of the invention has to do with an improvement in the dental technology of the customary so-called pontics, as it has existed up to now (intermediate links: These construction elements hang freely between anchorage teeth and are a functional replacement for a complete, missing tooth) in or for use in CAD/CAM technology for dental techniques.

Up to now, a pontic stored in a database is often proposed by the software as an intermediate link.

In the embodiment improved in accordance with the invention, an intermediate link, corresponding to the position of the tooth is taken from a database. Depending on the tastes of the dental technician, various pontic shapes can then be selected from the database, removed, and used. Proposals with the basic shapes “convex,” “concave,” “plane” are advantageous in the basic area of pontics. One aspect of the invention which has validity for the generally known state of the art has the possibility of offering an individual pontic database for the customer. The dental technician hereby designs his own politics using CAD technology, which he can deposit and store in an individual database. With a new dental situation, he can take the pontic which he designed himself from the customer database, make additional geometric changes and adapt them and incorporate them into the data set for the construction of the bridge.

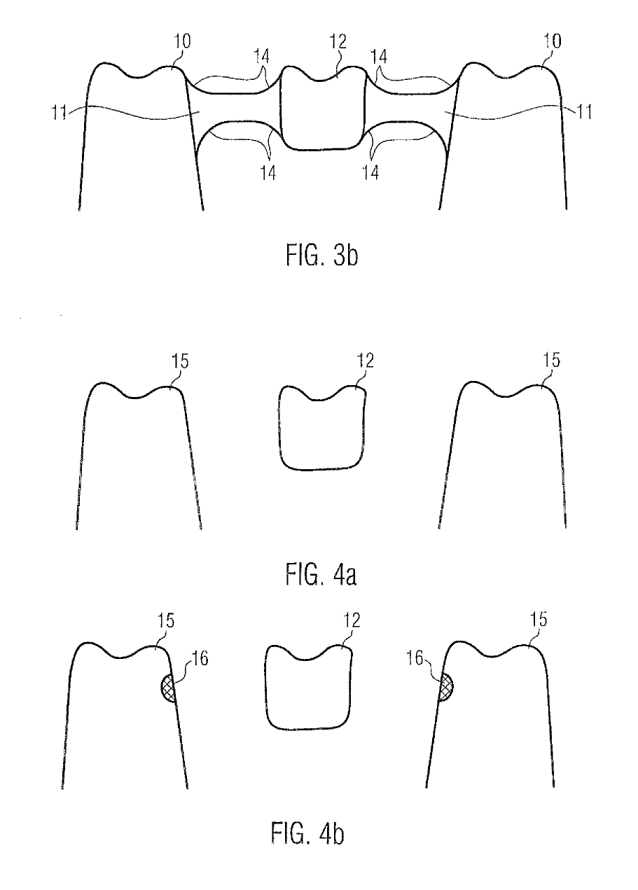

The selection can also be preset in the software by the dental technician in such a way that the shape favored by him automatically appears as the first proposal for the individual tooth position. Furthermore, he can determine and store an order of precedence of his favorites. This order of precedence is replaced according to each additional entry process, until he confirms this process with a special key function of the computer, for example, the “Enter” key. The same procedures described here can also be used for connecting elements (FIGS. 3a, 3b).

In another development, the library can be constructed on a standardized size, so to speak. If a dental technician selects a pontic, the positions and scalings of the pontic can be inserted in larger and smaller jaws from the programmed library using a method with a circle-tangent model (see FIG. 6). This spares a user a lot of manual computer work. Only for the sake of a better understanding will we also point out that the circle-tangent model is a schematized execution of a human jaw model.

5. Automatic Shape Adaptation for the Connecting Link/Crown Transition

This aspect of the invention is an improvement in the dental technology of the usual so-called connecting elements or connecting webs between tooth crowns and pontics as it has existed up to now.

In the hitherto state of the art, a rod-like connecting element which can be shaped was selected. The transition between the connecting element and the crown has been sharp-edged up to now. This desired effect was weakened by the CAM calculation of commercial CAM modules for milling technology, more or less as a waste product, since 3D milling path calculations are not able to mill such sharp-edged transitions.

In accordance with the new invention, the data set is already investigated, by software, within the framework of the modulation software (CAD module), especially on these sites on which two data sets to be merged (for example, that of a crown and that of a connecting element and that of a pontic) meet one another. Depending on the form of the data sets meeting one another, an automatic rounding off is then produced. The radiusing can, for example, take place by means of a prespecified or selectable radius. It can, however, also take place in a completely automatic manner, in accordance with the anatomical circumstances of the special tooth position in the jaw (for example, molar area, 4th tooth, left, etc.). Parameters characteristic of the individual position can be deposited in a database, which are automatically loaded when the position is recognized. A third possibility consists in the software investigating the adjacent surrounding surfaces and undertaking an as uniformly acting surface adaptation as possible by means of a so-called triangulation network relaxation (FIGS. 3a, 3b). Another possibility consists in depositing complete connecting element shapes, including radiusings, in a database (for example, determined by scanning manually made wax connecting elements).

6. Individual Abutments

The starting basis with this aspect of the invention is, furthermore, that three-dimensional data of a human jaw with implant posts are available. This aspect of the invention is an improvement in the dental technology of the common so-called abutments which has existed up to now.

The hitherto known state of the art permits the use of abutment blanks, which have to be adapted to the given dental situation in arduous manual work.

The spatial position and shape of implant posts and perhaps adjacent teeth in the jaw model is determined by means of a 3D scan. A deduction as to the exact position of the implant post can be made with the aid of a 3D configuration of the 3D scan, already known also by scanning.

Then, a stored abutment suitable for the position of the tooth in the jaw model is taken from a database. This abutment was stored parametrically and its shape can be changed by means of software technology as, for example, in FIG. 2b. The abutment is placed on the implant post on the screen and it can be changed in accordance with the situation. In addition to the parametric input possibilities (see FIG. 2b), morphing functions can also be consulted for the surface processing to change the abutment.

The changed data are stored and can be turned over to CNC software for the production of an individual abutment.

Alternatively, a desired abutment can be molded with wax on the implant post. This wax model is scanned in a second scanning process (surface data). Either the configuration data scanned previously or the previously known configuration of the implant post are brought together by means of software with the surface data set of the wax model, so that a completed shape data set of an abutment is produced (upper side and underside brought together).

These data are turned over to CNC production software and subsequently milled with a CNC machine.

7. Maryland Bridges

The starting basis with this aspect of the invention is, furthermore, that three-dimensional data of a human jaw with tooth gaps are available. This aspect of the invention is an improvement in the dental technology of common so-called Maryland bridges, as it is known up to now.

The starting situation is a tooth gap between two adjacent teeth. The measurement data of this situation are available. Instead of the tooth gap, a bridge is to be cemented in between the two adjacent teeth.

For the Maryland bridge, the dental technician marks the later cementing surfaces (for example, a circular shape projected onto the surface of the tooth) on the adjacent teeth bordering on the bridges. The Maryland bridge is subsequently constructed on the screen, based on the measurement data of the situation, including the cementing surface. After the marking of the cementing surfaces, an automatic proposal (pontics, connecting element), which can be subsequently modified by the dental technician is generated by the software.

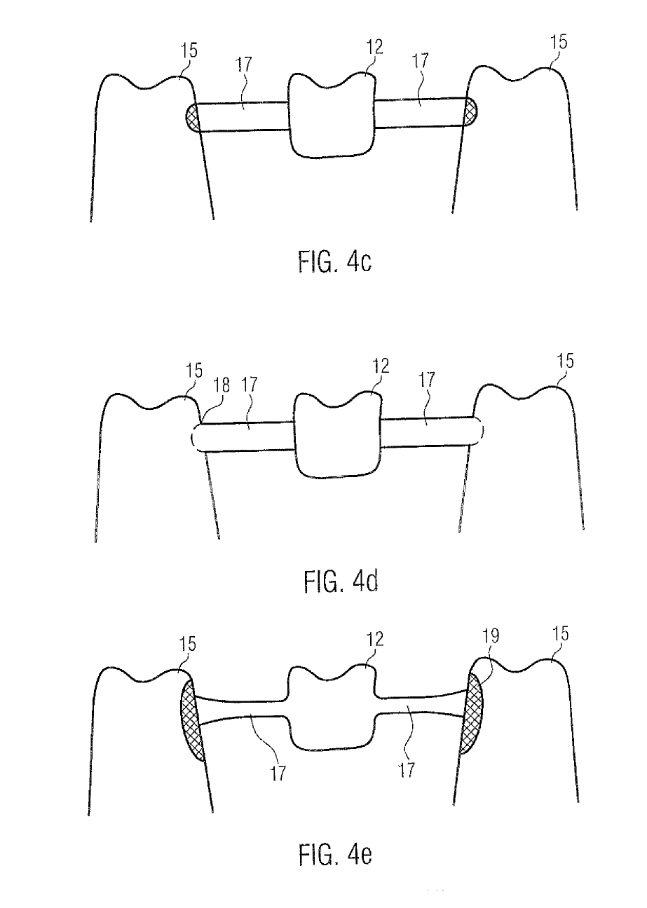

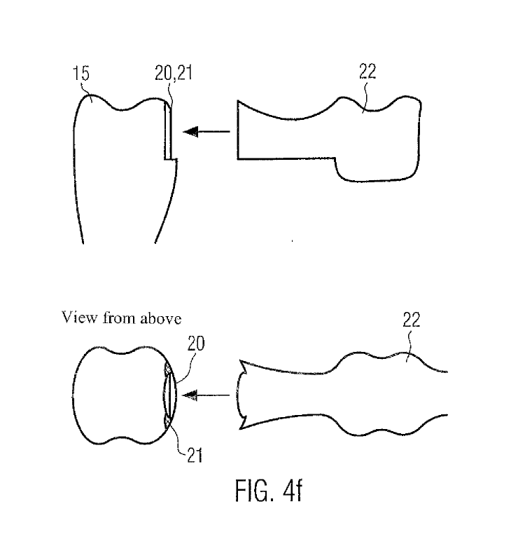

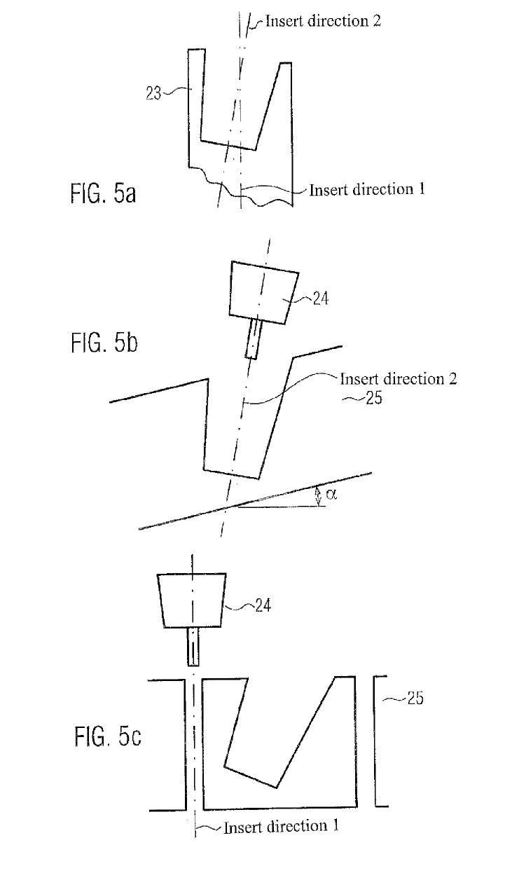

For example, in a first step, a pontic from a database is loaded and brought to the site of the tooth gap (FIG. 4a)—the indicated order of preference of the method steps is not compulsory thereby, but rather can be adapted, especially in accordance with other requirements. In the next step, a mark is placed on the adjacent teeth on the screen, on which the cementing sites are to be found for the Maryland bridges. The mark can represent all possible surface shapes, for example, a projected circle. Proceeding from this mark, the software generates a connecting element (FIG. 4c). Marks can also be placed on the pontic. The connecting elements are merged by software technology. At the end of the connecting element, radiusings can be produced in a completely automatic manner. This is particularly advantageous with the Maryland gap, since in this way the cementing surface and the total stability are clearly increased (FIG. 4e).

Alternatively, the pontic and the connecting element can be imported. On the cutting edge to the adjacent tooth, the software can carry out a “cutting-off process”—that is, the connecting element is cut off by software technology and perhaps subsequently radiused by the software.

Another advantageous development consists in introducing one or more recess grooves before the first measurement in the adjacent tooth, which increase the breaking strength of the Maryland bridge construction at the cementing site, after which tile grooves can be formed as a mechanical stop (FIG. 4f).

Then the data set is turned over to a CNC machine for production. Subsequently, the bridge is cemented in.

Other steps of the method and components of the device for this aspect of the invention are shown and clarified in FIGS. 4b and 4d.

8. Scanning of the Fittings

This aspect of the invention has to do with an improvement in the dental technology of common so-called fittings in CAD bridge constructions.

The scanning of fittings is used for the construction aid of complex operations on the screen. After the first measurement, rough fittings are made by the dental technician on the plaster model with wax (The Etkon Company has developed for example, a special scanning wax); the fittings are measured in a second scanning run. The two scans can also be correlated with one another in a very accurate manner by means of a mathematical method (matching). The fittings can be faded in or out on the screen as a construction aid or can be depicted in a transparent manner. Since the fitting is made in only a rough manner (for a rough orientation), there is no great expenditure of time by the dental technician (often, a fitting already exists).

9. Colored Wall Thickness Controls

This aspect of the invention has to do with an improvement in the dental technology of common so-called wall strength controls as it has existed up to now.

During the modeling or the modeling on the screen, the dental technician can evaluate the changes in the wall strengths in that the local wall strengths of the restoration are depicted on the screen marked in colored gradations. A transparent depiction is also possible.

10. Method for the Production of Inlays by Means of a Copy-Cad Function

This aspect of the invention has to do with an improvement in the dental technology of common so-called inlays as it has existed up to now.

Production Method for Inlays.

The cavity is scanned. Afterwards, an edge detection is carried out. Then, the inlay in the model is molded with wax, and in this state it is scanned once again. The two measurement data sets are superimposed by means of 3D matching. Finally, the difference data set is calculated (this is the volume of the inlay). The new peculiarity is that the previously carried out edge detection for the determination of the boundary (because of precision reasons) is used.

An explicit edge detection can also be dispensed with, and by means of a combined method of the “correlation” (superimposition of two scans) and the “distance detection” of the two scans, it is possible to filter out those areas/points which are relevant for an inlay (or expressed in another manner, a method for the volume subtraction is used). A substantial advantage of this variant is the fully automated operation which is possible with it.

11. 3Detection of the Spatial Position of Implant Posts in the Mouth of the Patient

This aspect of the invention has to do with an improvement in the dental technology of the common so-called implant post technology as it has existed up to now.

In a first step, the spatial position of the implant posts or the implant screws is determined by scanning a plaster model situation, wherein this can also be done via so-called “dummy implants” whose configuration is already known and which are characterized in that these dummy bodies can be measured better and are also better suited, so that the spatial positions of the implants can be determined via mathematical operations. In a second step, the configuration data of the implant posts (according to the manufacturer's specifications) are imported. The imported data are matched with the data ascertained during the 3D measurement and displayed on the screen. The precision is increased by the import of the theoretical data. In a next step, crown and bridge constructions are constructed on the screen on the basis of the previously described software steps, and are transmitted for production on the CNC machine.

12. Method for the Production of Primary Crowns.

This aspect of the invention has to do with an improvement in the dental technology of common so-called primary crowns as it has existed up to now.

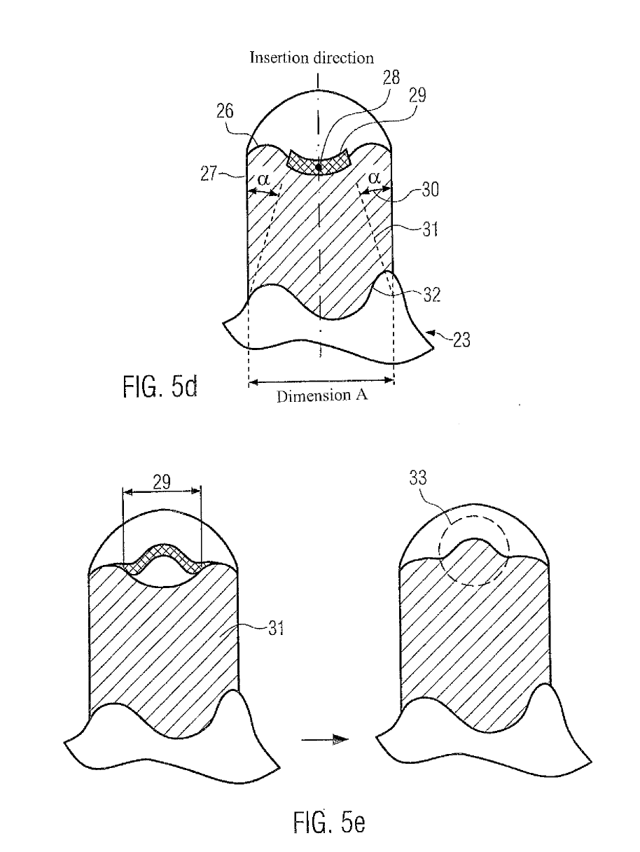

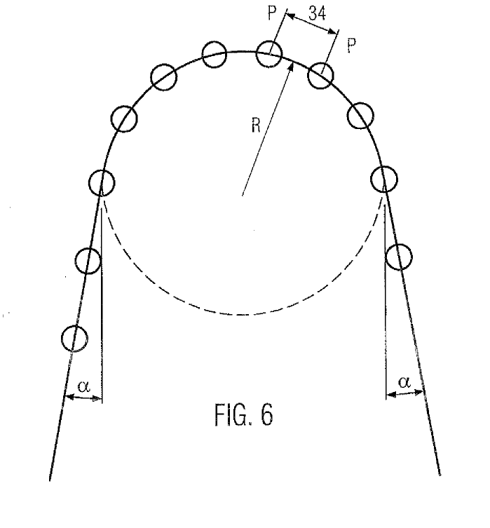

A software-generated primary crown from the state of the art known from the applications of Willytec GmbII has smooth surfaces on the outside which, from the view shown in FIG. 5d, can run parallel or conically relative to the insertion direction (FIG. 5d, angle alpha would be a cone angle). Depending on the position of the surfaces, a new topography of the primary crown is produced (for example, by changing dimension A, FIG. 5d). In accordance with the invention, a number of changes on the configuration of the primary crown can be changed by means of software. For example, wall thickness parameters can change dimension A in FIG. 5d, or the entry of cone angles (alpha).

The processing of friction lines (FIG. 5d), however, is essential for the development of primary crowns from the viewpoint of the dental technician. The invention stipulates that the dental technician can first mark a friction line which is geometrically present and visible on the screen. Then, he can mark a site on the friction line (point). Proceeding from this point, he can select an effect area in accordance with FIG. 5d—that is, the width of the site to be changed. In the next step, he can pull the fraction line at this point over the selected effect area upwards, downwards, inwards, or outwards (FIG. 5e). A new topography of the primary crown results therefrom, with an automatic retention (software-controlled) of the parallelness to the insertion direction or with retention of the cone angle.

The same is true for the two friction lines. If the dental technician, for example, pulls the friction line outwards, then the software in accordance with the invention is made in such a way that the corresponding friction line is also pulled. This is necessary in order to retain the parallelness or the cone angle.

Another invention has to do with the production of primary crowns, in particular, by means of the so-called 3+1 (angular) axis milling technique.

Since primary crowns have two insertion directions, it is particularly advantageous to align the milling cutter exactly in accordance with the insertion direction during the milling process (FIGS. 5a-5d). In the method of the invention, this takes place by tilting the milling blank or the milling cutter in accordance with the angle difference of the two insertion directions. In a first milling process, the milling cutter is aligned parallel to insertion direction 1. In this alignment, it processes all data which refer to insertion direction 1. Subsequently, the workpiece or the milling cutter is aligned in accordance with insertion direction 2 and it processes all data which refer to insertion direction 2 (FIGS. 5a to 5d). By means of this milling cutter strategy, especially good surface qualities and fits on all those surfaces which lie parallel to insertion directions can be generated. The separate adjustment of the stump insertion direction (insertion direction 2) acquires a special significance in only “4 axes,” since in this way the very expensive 5-axes technique can be dispensed with. The entire model is rotated around the Z axis in such a way so that any undercuts present in precisely the 4th axis can be ruled out. In this way, a rather expensive 5th axis can be dispensed with. This is very important for a successful use of the primary crown technique.

Other details can be deduced from FIG. 5e.

13. Milling of Undercuts in Bridge Constructions:

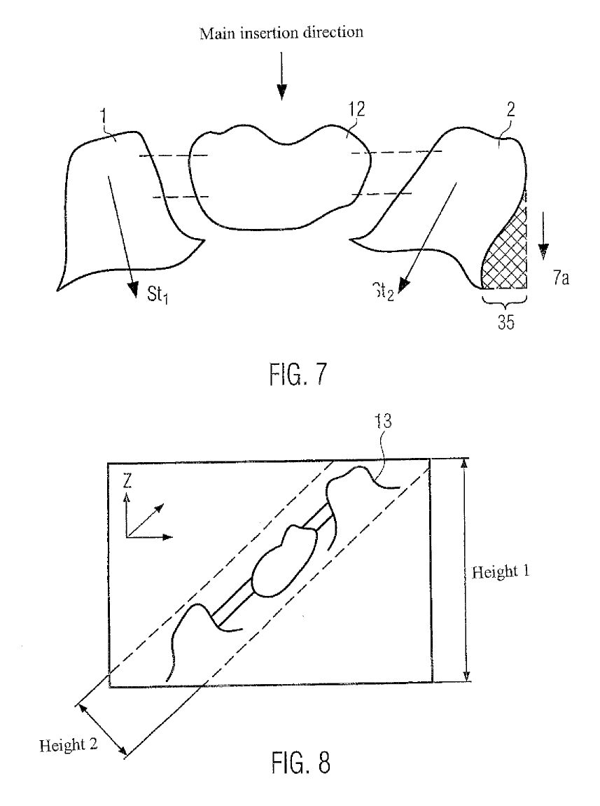

It often occurs in dental technology that a main insertion direction for a multimember bridge can be set up without producing excessively strong undercuts in individual stumps, as is clarified in FIG. 7 (see detail 7a). A rear-cut correction, as in connection with the method which can be realized by software in accordance with the embodiment example can attain suitable corrections such as the removal of undercuts in individual stumps, but may have the disadvantage that jutting edges are produced, as is made clear in FIG. 7 (see detail 7a).

A solution in accordance with the invention is to be found in that, by a corresponding method the preceding disadvantages can be minimized or completely eliminated. An additional insertion direction St₂ is determined in accordance with the method for example by software, and sent on to a milling machine. Furthermore, limitations in accordance with the method, such as software-technical limitations, prevent such a bridge from being used any longer.

In addition, it is possible to select the direction of the St₂ stump with the preceding methodology, analogous to the primary crown technique described further above, using an appropriate method in such a way that instead of a 5-axes machine for the processing, only a 4-axes machine is required.

14. Expansion of the Primary Crowns (Primary Constructions), Secondary Construction, and Tertiary Construction

In dental technology, it is common to set up directly on the primary constructions, a bridge construction (secondary construction), or via the intermediate step of, for example, “galvanic-secondary elements,” a tertiary construction which can be removed or is fixed. The method presented here greatly facilitates this process, since the geometric data of the primary element are already stored and a bridge construction can be set up on them in a very simple manner via special method functions, or especially software functions.

15. “Uphill/Downhill Milling”

The “uphill/downhill milling” is characterized by an optimized alignment of a milling blank with the part to be milled. With multimember bridges, the use of a clearly thicker blank is often required, as is illustrated schematically in FIG. 8, since in 3-axes machines the processing of the blanks is possible in only two directions. By the calculation of the minimum volume in the right direction and transformation of the bridges in the space, it is possible to use a clearly smaller blank for the milling of the bridge. This is made clear by the comparison of on the one hand height 1 and on the other hand optimized height 2 in FIG. 8. Thus, it is possible to use a clearly more optimized milling strategy with a 5-axes machine.

16. “Copy-Cad Wax”

A very widespread problem is the scanning of molding waxes, since the partially permeable wax structure can be scanned poorly or not at all. Particularly by the addition of at least ⅓ to ⅘ parts by weight of zirconium oxide powder, the wax can be scanned very well, without thereby losing the typical molding characteristics. Such an effect was not observed when other substances were added.

Other embodiment possibilities and expansions for the embodiment examples explained individually in the preceding are indicated below.

In order to facilitate the work with the determined data, for example, for a denture element, provision can be made so that a colored depiction of surface areas takes place. To this end, the data or an electronic image produced therefrom, such as on a computer screen, can either be selected freely or divided into surface areas, manually or automatically with the aid of prespecified criteria. Then, these subdivision and/or surface areas are correlated with individual color boundaries or colors and a corresponding depiction is produced.

Thus, for example, the inside of the denture element can be correlated with a specific area. The division has the advantage that special production information for specific areas can be deposited. For example, the milling by a machine should be more precise on the inside of a denture element than on the outside. The work should be particularly precise in the area of the preparation boundary. For this, for example, the work must be done by a machine with a smaller tool, a higher rpm, and small advances.

The graduation in such areas is deposited in a generally valid data format after the production of the mold data sets, which is independent of the mode of production (for example, milling, laser sintering, etc.) or the production machine. As an example of such a format, an STL format with supplementary information could be used. This format can be transmitted to various further processing systems (CAM).

If in the preceding the discussion has to do with software or its specification, design, implementing, and application, this should always be understood as a realization of the invention within the scope of a corresponding embodiment example and as a method, and also by correspondingly suitable and required apparatuses and devices. Basically, with the corresponding data all other possible method realizations and in particular automations are also clear for a specialist. To be on the safe side, however, it will be pointed out that all data which refer to software are to be generally understood as related to a method and/or devices.

The invention is depicted, merely by way of example, with the aid of the embodiment examples in the description and in the drawings and is not limited to them, but rather comprises all variations, modifications, substitutions, and combinations which the specialist can deduce from the documents under consideration, particularly within the framework of the claims and the general representations in the introduction of this description and the description of the embodiment examples and their representations in the drawing, and which he can combine with his technical knowledge and the state of the art. In particular, all individual features and development possibilities of the invention and their embodiment examples can be combined.

The designations in the figures of the drawing are as follows:

1 tooth stump 1
2 tooth stump 2
3 web
4 workpiece which can be milled
5 tooth situation (here, broken lines)
6 removable secondary/tertiary construction as an example
7 data set, dental bridge
8 data set, geometrically defined pin
9 merged data from data set, dental bridge and data set, geometrically defined pin
10 crown
11 connecting element (for example, rod-shaped)
12 pontic
13 bridge
14 radiusings
15 adjacent tooth
16 marks
17 intermediate link
18 cutting edge
19 radiusing with larger cementing surface
20 marked point
21 effect area
22 Maryland bridge
23 primary crown
24 milling cutter
25 material blank
26 friction line, above
27 surface, parallel to insertion direction
28 marked point
29 effect area
30 imaginary cone angle a
31 smooth surface
32 friction line, below
33 result
34 distance
35 boundary close

1. Method for the production of denture elements with a digital acquisition of the surface data of a remaining dental area, three-dimensional design of at least one molded part, in particular, a denture element for the remaining dental area, including the acquired surface data of the remaining dental area; and the preparation of corresponding mold data; and a partial or complete production of the at least one denture element on the basis of the surface data and mold data, characterized in that
within the framework of the three-dimensional design of the at least one molded part, a three-dimensional design of web constructions between tooth stumps and the preparation of corresponding mold data takes place; and
that the mold data of the three-dimensional design of the web constructions between the tooth stumps for the production of the dental element are passed on to a production device for partial or complete production.

2. Method for the production of denture elements according to claim 1, characterized in that the design steps are undertaken by means of computer devices.

3. Method for the production of denture elements according to claim 1, characterized in that the web constructions are designed in such a way that they are shaped at right angles and/or in the form of a trapezoid.

4. Method for the production of denture elements according to claim 1, characterized in that, in the design, a symmetry plane is used, which serves simultaneously as an insertion direction of a later superconstruction.

5. Method for the production of dental elements according to claim 4, characterized in that a cone angle is indicated with reference to the symmetry plane.

6. Method for the production of denture elements according to claim 4, characterized in that several webs are shaped between several tooth stumps, wherein all webs have the same insertion direction.

7. Method for the production of denture elements according to claim 1, characterized in that the mold data are also used for the processing of another molded part, which is adapted precisely to the shaped surface contour.

8. Method for the production of denture elements according to claim 1, characterized in that the denture element is produced from materials which contain over 80 vol % zirconium oxide ceramic or titanium or chromium cobalt.

9. Method for the production of denture elements with the digital acquisition of the surface data of a remaining dental area, the three-dimensional design of at least one molded part, in particular, of a denture element for the remaining dental area, including the acquired surface data of the remaining dental area and the preparation of the corresponding mold data, and the partial or complete production of the at least one denture element on the basis of the surface data and the mold data, characterized in that
the surface data of a three-dimensional dental impression, which was produced by the introduction of a moldable material between the upper and lower jaws of a patient while the teeth were being pressed together, are acquired on one side, on two sides (both sides), or on several sides;
both the surface data of the remaining dental area and also the surface data of the dental impression are depicted, wherein
in one step, the surface data of the remaining dental area of a plaster model are measured;
in another step, the plaster model is brought to a defined relative position for the measuring device; the dental impression is subsequently placed on the plaster model; and the entire model with the plaster impression is measured;
in another step, the spatial position of the data of the plaster model and the data of the dental impression, relative to one another, are depicted and examined on a screen; and
in another step, the denture element is shaped with the aid of the depictions of the plaster model and the dental impression.

10. Method for the production of dental elements according to claim 9, characterized in that in the depiction of the dental impression placed on the plaster model, the dental impression can fade in and out and/or is transparent.

11. Method for the production of dental elements with the digital acquisition of the surface data of a remaining dental area, the three-dimensional design of at least one molded part, in particular, a denture element for the remaining dental area, including the acquired surface data of the remaining dental area and the preparation of the corresponding dental data, and the partial or complete production of the at least one denture element on the basis of the surface data and the mold data, characterized in that
an entire mold component is created from a combination and/or merger of the configuration data of the at least one predefined, three-dimensional body with the mold data of at least one three-dimensionally shaped denture element.

12. Method for the production of denture elements according to claim 11, characterized in that at least one such developed, predefined, three-dimensional body is used; that it is used as a mechanical connecting element to at least one adjacent denture element.

13. Method for the production of denture elements according to claim 11, characterized in that the at least one predefined geometric body contains at least one cylindrical development.

14. Method for the production of denture elements according to claim 13, characterized in that the placement, alignment, position, and/or dimensions, in particular, the spatial position, height, and/or diameter of the cylindrical development can be changed during the creation of the entire mold component.

15. Method for the production of denture elements according to claim 11, characterized in that as predefined geometric bodies, parts of a rod attachment are used for the connections of two bridge elements, and that the insertion directions required for the construction of a rod attachment can be fixed.

16. Method for the production of denture elements according to claim 15, characterized in that as a counterpiece, a second rod attachment element of a second denture element can be determined for the first rod attachment element of a first denture element by means of three-dimensional volume subtraction.

17. Method for the production of denture elements according to claim 11, characterized in that the predefined geometric bodies are developed as intermediate links or pontics of a dental bridge and are taken from a database.

18. Method for the production of denture elements according to claim 17, characterized in that in the database, several different variants of a prespecified intermediate member, intended for a specific jaw position, are deposited.

19. Method for the production of denture elements according to claim 18, characterized in that the deposited variants are developed in the basal area, either convex or concave or plane.

20. Method for the production of denture elements according to claim 17, characterized in that in the database, various sizes of the individual pontic variants, prespecified for a specific jaw position, as a function of the size of the jaw, are deposited, wherein the jaw size is taken into consideration in the selection.

21. Method for the production of denture elements according to claim 17, characterized in that individual variants of at least one intermediate member intended for a specific jaw position are stored.

22. Method for the production of denture elements according to claim 17, characterized in that a specific variant of a pontic provided for a specific jaw position, is automatically determined as a first proposal to be taken into consideration for the further method.

23. Method for the production of denture elements according to claim 17, characterized in that, in addition to the pontics, connecting elements which are provided for the connection between the pontic and adjacent tooth are also stored in a database and are introduced or fit into the total construction.

24. Method for the production of denture elements according to claim 17, characterized in that, in the merger of various geometric bodies, the transition to the connecting sites is radiused, wherein in the radiusing, stability criteria and anatomical mold criteria according to the specifications of natural tooth shapes are taken into consideration.

25. Method for the production of denture elements according to claim 24, characterized in that the radiusing is shaped in such a way that the shape produced can be produced with a rotating milling tool.

26. Method for the production of denture elements according to claim 25, characterized in that the milling toot has a defined tip radius, which is formed larger than 0.1 mm.

27. Method for the production of denture elements with a digital acquisition of surface data of a remaining dental area, a three-dimensional design of at least one molded part, in particular, of a denture element for the remaining dental area, including the acquired surface data of the remaining dental area and the preparation of corresponding mold data, and the partial or complete production of the at least one denture element on the basis of the surface data and mold data, characterized in that
in the digital acquisition of surface data of a remaining dental area, data concerning the spatial position and shape of at least one implant post are also acquired,
from a database, a stored abutment suitable for the position of the tooth which the implant post replaces is selected; and
in a depiction of the remaining dental area with the implant post, this abutment is placed on the post and adapted to the remaining dental area.

28. Method for the production of denture elements according to claim 27, characterized in that abutments are stored parametrically in the database so that their shapes can be changed for adaptation to the remaining dental area and/or the adaptation of an abutment to the remaining dental area using morphing functions for the surface processing is carried out on the basis of data to change the abutment.

29. Method for the production of denture elements according to claim 27, characterized in that the changed data of an adapted abutment are stored and passed on to a CNC process for the production of an individual abutment, in particular, by subsequent milling with a CNC machine.

30. Method for the production of denture elements with the digital acquisition of surface data of a remaining dental area, the three-dimensional design of at least one molded part, in particular, a denture element for the remaining dental area, including the acquired surface data of the remaining dental area and the preparation of corresponding mold data, and the partial or complete production of the at least one denture element on the basis of the surface data and mold data, characterized in that
a desired abutment is molded with wax on an implant post;
this wax model is detected in a separated scanning process in accordance with the data; and
scanned or previously known configuration data of the implant post are brought together with the surface data set of the wax model in such a way that a complete mold data set of an abutment is produced when the upper side and the underside are brought together.

31. Method for the production of denture elements according to claim 30, characterized in that the complete mold data set of an abutment with the upper side and the underside brought together is stored and can be passed on to a CNC process for the production of an individual abutment, in particular, by subsequent milling with a CNC machine.

32. Method for the production of denture elements with the digital acquisition of surface data of a remaining dental area, the three-dimensional design of at least one molded part, in particular, a denture element for the remaining dental area, including the acquired surface data of the remaining dental area and the preparation of corresponding mold data, and the partial or complete production of the at least one denture element on the basis of the surface data and mold data, characterized in that
the surface data are depicted graphically;
at least one mark is made on the graphic depiction of the surface data; and
the mold data for a denture element are constructed on the basis of the surface data, including the mark in the graphic depiction of the surface data.

33. Method for the production of denture elements according to claim 32, characterized in that a proposal, taking into consideration the mark, is produced automatically for the denture element by data processing devices.

34. Method for the production of denture elements according to claim 32, characterized in that a denture element is produced in the form of a bridge, in particular, a Maryland bridge, for a tooth gap between two adjacent teeth in the remaining dental area.

35. Method for the production of denture elements according to claim 34, characterized in that a mark is placed on the graphic depiction of the surface data of each adjacent tooth.

36. Method for the production of denture elements according to claim 35, characterized in that a circular form projected onto the depiction of the tooth surface is used as a mark.

37. Method for the production of denture elements according to claim 35, characterized in that the bridge, in particular the Maryland bridge, is constructed subsequently on a screen based on the measurement data of the situation, including the cementing surface.

38. Method for the production of denture elements according to claim 32, characterized in that an automatic proposal, in particular, of pontics or connecting elements, is generated after marking the cementing surfaces.

39. Method for the production of denture elements according to claim 38, characterized in that the automatically generated proposal is modified.

40. Method for the production of denture elements according to claim 39, characterized in that a pontic is loaded from a database and brought to the site of the tooth gap.

41. Method for the production of denture elements according to claim 39, characterized in that a mark is placed on the screen on each of the adjacent teeth on which the cementing sites for a Maryland bridge are found.

42. Method for the production of denture elements according to claim 41, characterized in that, proceeding from this mark, a data set for a connecting element is generated by data processing devices.

43. Method for the production of denture elements according to claim 42, characterized in that marks are also placed on the data set of the pontic.

44. Method for the production of denture elements according to claim 43, characterized in that the data sets of the connecting elements are merged with the data set of the pontic by means of data processing devices.

45. Method for the production of denture elements according to claim 44, characterized in that, at the end of a connecting element, radiusings are produced in its data set in a completely automatic manner.

46. Method for the production of denture elements according to claim 32, characterized in that the pontic and the connecting element are imported from a database.

47. Method for the production of denture elements according to claim 46, characterized in that a “cutting off process” is carried out on the cutting edge to the adjacent tooth by means of data processing devices.

48. Method for the production of denture elements according to claim 47, characterized in that the data set of the connecting element are cut off and preferably subsequently radiused.

49. Method for the production of denture elements according to claim 32, characterized in that one or more recess grooves are introduced as a mechanical stop before a first measurement in an adjacent tooth.

50. Method for the production of denture elements according to claim 32, characterized in that the finished data set for the bridge, in particular, the Maryland bridge, together with the connecting link, are passed on to a CNC machine for production.

51. Method for the production of denture elements according to claim 32, characterized in that each mark is established in accordance with later cementing surfaces.

52. Method for the production of denture elements with the digital acquisition of the surface data of a remaining dental area, the three-dimensional design of at least one molded part, in particular, a denture element for the remaining dental area, including the acquired surface data of the remaining dental area and the preparation of corresponding mold data, and the partial or complete production of the at least one denture element on the basis of the surface data and mold data, characterized in that
rough fittings are made on the plaster model with wax after a first measurement;
the rough fittings are measured in a second scanning process, and
the two scans are correlated with one another in a very precise manner.

53. Method for the production of denture elements according to claim 52, characterized in that the correlation is carried out via a mathematical process, in particular, matching.

54. Method for the production of denture elements according to claim 53, characterized in that the data of the fittings are faded in and out as a construction aid on the screen or are depicted transparent.

55. Method for the production of denture elements with the digital acquisition of surface data of a remaining dental area, the three-dimensional design of at least one molded part, in particular, a denture element for the remaining dental area, including the acquired surface data of the remaining dental area and the preparation of the corresponding mold data, and the partial or complete production of the at least one denture element on the basis of the surface data and the model data, characterized in that
during a modeling on a screen for the recognition of changes of the wall thicknesses, the local wall thicknesses of the restoration are marked in colored gradations or are depicted partially transparent on the screen.

56. Method for the production of denture elements with the digital acquisition of surface data of a remaining dental area, the three-dimensional design of at least one molded part, in particular, a denture element design of at least one molded part, in particular, a denture element for the remaining dental area, including the acquired surface data of the remaining dental area and the preparation of corresponding mold data, and the partial or complete production of the at least one denture element on the basis of the surface data and the mold data, characterized in that
a cavity is scanned;
edge detection is subsequently carried out;
afterwards, an inlay is molded in the model with wax, and is scanned once again in this state;
the two measurement data sets are superimposed by means of 3D matching; and
a difference data set is finally calculated.

57. Method for the production of denture elements with the digital acquisition of surface data of a remaining dental area, the three-dimensional design of at least one molded part, in particular, a denture element for the remaining dental area, including the acquired surface data of the remaining dental area and the preparation of the corresponding mold data, and the partial or complete production of the at least one denture element on the basis of the surface data and mold data, characterized in that
a cavity is scanned;
afterwards, an inlay is molded in the model with wax and is scanned once again in this state;
via a combined method of the “correlation” in the form of superimposition of two scans and the “distance detection” of the two scans, those surfaces/points which are relevant for an inlay are filtered out; and
a difference data set is subsequently calculated.

58. Method for the production of denture elements with the digital acquisition of surface data of a remaining dental area, the three-dimensional design of at least one molded part, in particular, a denture element for the remaining dental area, including the acquired surface data of the remaining dental area and the preparation of the corresponding mold data, and the partial or complete production of the at least one denture element on the basis of the surface data and the mold data, characterized in that
a method for the volume subtraction is used.

59. Method for the production of denture elements with the digital acquisition of surface data of a remaining dental area, the three-dimensional design of at least one molded part, in particular, a denture element for the remaining dental area, including the acquired surface data of the remaining dental area and the preparation of the corresponding mold data, and the partial or complete production of the at least one denture element on the basis of the surface data and the old data, characterized in that
in a first step, the spatial position of implant posts or implant screws is determined by scanning a plaster model situation;
in a second step, the configuration data of the implant posts, in particular, in accordance with tie manufacturer's specifications, are imported;
the imported data either be matched with the data determined in the 3D measurement or displayed on the screen; and
in a next step, crown or bridge constructions are constructed on the screen on the basis of the preceding steps and are transmitted to the CNC machine for production.

60. Method for the production of denture elements according to claim 59, characterized in that the step of the importation of the configuration data of the implant posts is undertaken via “dummy implants” whose configuration is already known and which are characterized in that these dummy bodies can be better measured and are also more suited so that, via mathematical operations, the spatial positions of the implants can be determined as the implant posts or implant screws which are actually to be used.

61. Method for the production of denture elements with the digital acquisition of surface data of a remaining dental area, the three-dimensional design of at least one molded part, in particular, a denture element for the remaining tooth area, including the acquired surface data of the remaining tooth area and the preparation of the corresponding mold data, and the partial or complete production of the at least one denture element on the basis of the surface data and the mold data, characterized in that
for the development of primary crowns, a geometrically present friction line which is visible on a screen, is selected from their data set;
a site or a point of the friction line is then marked;
proceeding from this point, an effect area is selected—that is, the width of a site to be changed;
in the next step, the friction line at this point is pulled over the selected effect area upwards, downwards, inwards, or outwards; and
a new topography of the primary crown is produced therefrom, with an automatic retention of the parallelness to the insertion direction or with retention of the cone angle.

62. Method for the production of denture elements according to claim 61, characterized in that two friction lines are treated in such a way that, when one friction line is pulled, the other corresponding friction line is also pulled.

63. Method for the production of denture elements with the digital acquisition of the surface data of a remaining dental area, the three-dimensional design of at least one molded part, in particular, a denture element for the remaining dental area, including the acquired surface data of the remaining dental area and the preparation of the corresponding mold data, and the partial or complete production of the at least one denture element on the basis of the surface data and mold data, characterized in that
primary crowns are made by means of the 3+1 or angular axis milling techniques.

64. Method for the production of denture elements according to claim 63, characterized in that since primary crowns have two insertion directions, the milling cutter is aligned exactly in accordance with the insertion direction during the milling process.

65. Method for the production of denture elements according to claim 64, characterized in that the milling cutter is aligned exactly in accordance with the insertion direction during the milling process, in that the milling blank and/or the milling cutter is/are tilted in accordance with the angle difference of the two insertion directions.

66. Method for the production of denture elements according to claim 64, characterized in that, in a first milling run the cutter is aligned parallel to a first insertion direction, and in this alignment all data which refer to the first insertion direction are processed, and that subsequently the workpiece and/or the milling cutter is aligned in accordance with a second insertion direction, and all data which refer to the second insertion direction are processed.

67. Method for the production of denture elements with the digital acquisition of the surface data of a remaining dental area, the three-dimensional design of at least one molded part, in particular, a denture element for the remaining dental area, including the acquired surface data of the remaining dental area and the preparation of the corresponding mold data, and the partial or complete production of the at least one denture element on the basis of the surface data and the mold data, characterized in that
to avoid undercuts, an additional insertion direction St₂ is determined and is passed on to a milling machine.

68. Method for the production of denture elements according to claim 66, characterized in that the direction of the St₂ stump is selected in such a manner that a 4-axes machine is sufficient for the processing.

69. Method for the production of denture elements with the digital acquisition of the surface data of a remaining dental area, the three-dimensional design of at least one molded part, in particular, a denture element for the remaining dental area, including the acquired surface data of the remaining dental area and the preparation of corresponding mold data, and the partial or complete production of the at least one denture clement on the basis of the surface data and mold data, characterized in that
by “uphill/downhill milling” an optimized alignment of a milling blank with the part to be milled is brought about.

70. Method for the production of denture elements with the digital acquisition of: the surface data of a remaining dental area, the three-dimensional design of at least one molded part, in particular, a denture element for the remaining dental area, including the acquired surface data of the remaining area and the preparation of the corresponding mold data, and the partial or complete production of the at least one denture element on the basis of the surface data and mold data, characterized in that
a molding wax with at least ⅓ to ⅘ parts by weight zirconium oxide powder is used for the scanning of molding waxes.

71. (canceled)
